(19) United States
(12) Patent Application Publication
(10) Pub. No.: US 2006/0216106 A1
(43) Pub. Date: Sep. 28, 2006

(54) Easy to open ring binder mechanism

(76) Inventor: Wang Yip Lam, Hong Kong (CN)

Correspondence Address: SHOEMAKER AND MATTARE, LTD, 10 POST OFFICE ROAD - SUITE 110, SILVER SPRING, MD, 20910, US

(21) Appl. No.: 11/090,901

(22) Filed: Mar. 25, 2005

(51) Int. Cl. B42F 13/20

(52) U.S. Cl. 402/31; 402/19

(57) ABSTRACT

The ease with which a metal ring binder mechanism can be opened is improved by adding at least one auxiliary helper spring for reducing the spring force applied by the spine to the blades which support the rings, so as to decrease the force required to open the rings, without affecting the page-retaining power of the binder mechanism.

### BACKGROUND OF THE INVENTION

This invention relates to an easy to open ring binder mechanism.

The most common type of ring binder mechanism intended for notebooks comprises three rings, each made in two halves. The lower end of each ring half is permanently connected to one of two blades which are held in compression, edge-to-edge, within a curved spine made of sheet metal. The blades toggle between a lowered position, in which the rings are closed, and a raised position, where the rings are open. A lever or trigger is usually installed at one or both ends of the spine, to assist a user in opening the rings, or in locking them closed.

In most ring binder mechanisms, the spine flexes as the rings are moved, and this flexure provides the only spring force that holds the rings in their closed and open positions. With this arrangement, the combined width of the blades, in the open or closed positions (see FIGS. 3 and 4) is somewhat greater than the distance between the edges of the spine, so that the blades are preloaded toward one another. As the blades pass an intermediate position, where they are coplanar and have a greater combined width, the spine flattens and becomes stressed more greatly. Consequently, the force between the ring tips varies (see solid line in FIG. 5) as the rings are moved from their fully closed to fully open position and back. There is an unstable neutral position between the open and closed positions; on either side of the neutral position, the rings have increasing spring bias towards the stop positions. At the closed position, the force required to separate the ring tips may be quite high. For this reason, it is common to provide two triggers, one at either end of the spine, for opening the rings. Single-trigger constructions, which do exist, may not provide satisfactory opening operation without the helper springs described herein.

A disadvantage of conventional ring binder mechanisms is that they are noisy, as every student knows. The combined loud reports of a classroomful of ring binders with the mechanisms being snapped open or shut at the beginning or end of a lecture can be quite distracting. The noise can be attributed to the high closing and opening forces encountered in a ring binder mechanism of conventional design.

Another disadvantage of conventional ring binder mechanisms is that their high closing force can painfully pinch the fingers. In addition, people with joint problems or arthritis often find it hard to open and close a ring binder.

It would be advantageous to reduce the opening and closing force, if one could do so without risking that the binder mechanism would come open unintentionally.

Prior inventions in this field include those described in U.S. Pat. No. 1,157,184, No. 2,381,040, No. 4,281,940, No. 4,552,478, No. 5,158,386, No. 5,393,156, No. 5,692,847, No. 5,782,569, No. 5,788,392, and No. 6,045,286.

### SUMMARY OF THE INVENTION

An object of the invention is to reduce the opening force of a ring binder mechanism, without affecting its paper-retention function.

A related object is to reduce the noise generated upon opening and closing the ring binder mechanism.

These and other objects are attained by providing a ring binder mechanism with at least one helper spring—preferably two or more, depending on the number of rings, spaced along the length of the binder mechanism—to moderate each ring's closing and opening force. Details of a preferred embodiment of the invention appear in the drawings, and are described below.

### BRIEF DESCRIPTION OF THE DRAWINGS

In the accompanying drawings,

FIG. 1 is a top plan view of a metal ring binder mechanism embodying the invention, with the rings closed;

FIG. 2 is a perspective view of the binder mechanism, from below;

FIG. 3 is a sectional view taken on the plane 3-3 in FIG. 1, showing the blades in the closed position of the binder mechanism;

FIG. 4 is a view like FIG. 3, showing the blades in the open position of the binder mechanism; and

FIG. 5 is a force diagram showing the effect of the helper springs.

### DESCRIPTION OF THE PREFERRED EMBODIMENT

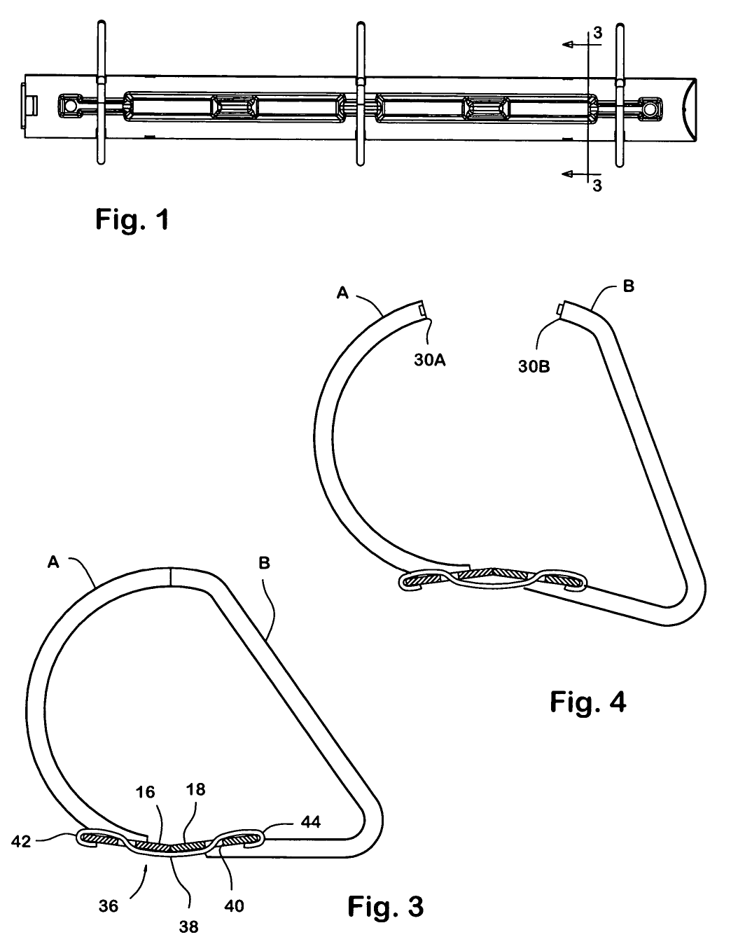

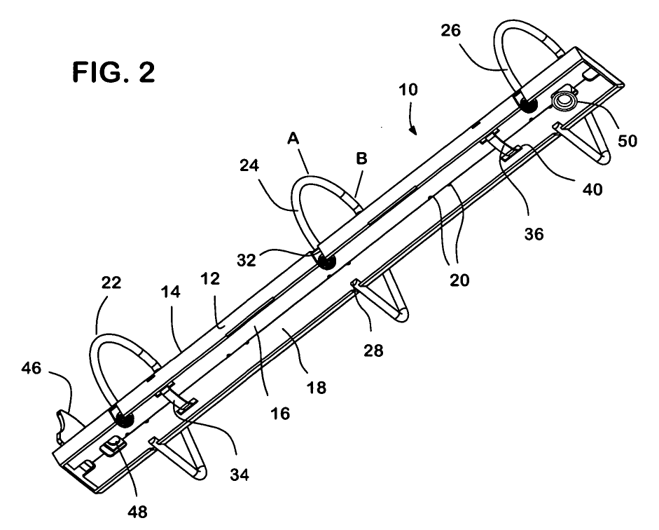

FIGS. 1 and 2 show a metal ring binder mechanism embodying the invention comprises a sheet metal spine 10 having a generally convex upper surface. The illustrated decorative embossing of the spine reinforces it somewhat, but is not important to this invention. The lateral edges 12 of the spine are bent inward toward one another along bend lines 14 so as to define seats which support the outer edges of a pair of flat sheet metal blades 16, 18. The inner edges of the blades are held in alignment by alternating swaged tabs 20. Three rings 22, 24, 26, each formed in two halves A,B, are supported by the blades, one end 28 of each ring half being rigidly affixed to a respective blade, as by welding or swaging. The tips 30A, 30B (FIG. 4) of the ring halves have features, such as a pin and socket or sinusoidal serrations, which mesh when the rings are closed to maintain alignment of the tips.

The upward (opening) movement of the blades is stopped by contact between the inner edges of the blades with the spine. The blades' downward movement is stopped by the engagement of the ring tips with one another.

The rings illustrated are asymmetrical, one half “A” being semicircular and protruding through an aperture 32 in the spine, the other “B” having a straight segment and extending around the corresponding edge of the spine, rather than going through it. The straight-segment design provides somewhat greater paper capacity. The shape of the rings is not particularly important to the basic features of this invention. For example, the principles of the invention could be applied to a binder mechanism having symmetrical semicircular ring halves.

The device as described so far is conventional. What is new is the helper leaf springs 34, 36 appearing in FIG. 2. Each of the helper springs is disposed near a respective ring, being offset toward the center of the spine side so as to avoid the ring halves.

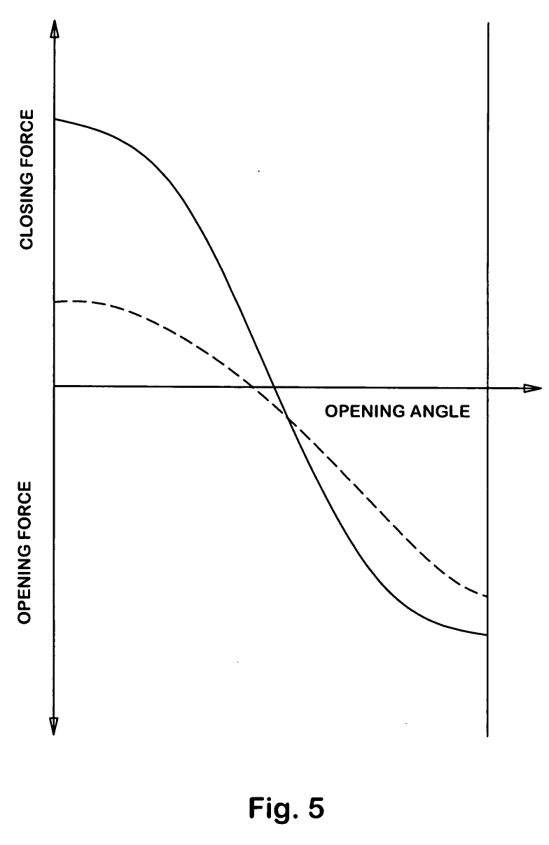

Each helper spring is made of spring steel. As shown in FIGS. 3 and 4, which represent the closed and open position of the binder mechanism respectively, each spring's center 38 bears against the bottom of the mating inner edges of the two blades when the binder mechanism is closed. The spring passes through slots 40 in the blades, and its ends 42, 44 are bent outward and down around the outer edges of the respective blades. Where its ends pass around the blade edges, each spring is permanently deformed to the shape shown. The width, thickness and material of the spring may be changed to alter its force diagram. An exemplary force diagram is shown in FIG. 5. The solid line is the force curve for the binder mechanism without helper springs; the broken line shows the force curve with helper springs installed. As one can see, the effect of the helper springs is greatest when the rings are closed, and the helper springs are most highly stressed. Therefore, the helper springs affect the force required to open the binder mechanism more strongly than they affect the force required to close it.

A single actuating lever 46 is illustrated in the drawings, but it is not described in detail inasmuch as it is conventional and does not affect the inventive features described above. Suffice it to say that one can open the rings by pressing the lever outward, away from the rings. The action is improved by the helper springs, however, so that not much effort is required on the part of the user, and when the rings open and close, they do so much more quietly. The presence of the helper springs ensures that the rings can be reliably opened with the application of only light pressure to the single actuating lever.

The holes 48 at the ends of the binder mechanism are for the eyelets 50 (only one of which is shown) through which rivets (not shown) are passed to secure the binder mechanism in a notebook.

An advantage of the invention is that it not only reduces the opening force required, but also reduces the closing force, which makes its operation quieter.

Since the invention is subject to modifications and variations, it is intended that the foregoing descriptions and the accompanying drawings shall be interpreted as only illustrative of the invention defined by the following claims.

I claim:

1. In a ring binder mechanism comprising a metal spine having lateral edges,
a pair of blades held in edgewise compression between the lateral edges of the spine whereby the spine provides a spring action affecting hinging movement of the blades, and
at least two rings formed in two halves, each ring half having a lower end affixed to one of the blades and a tip adapted to engage the tip of an opposite counterpart ring half when the rings are closed, the improvement comprising
at least one helper spring for reducing the spring action of the spine upon the blades so as to decrease the force needed to open the rings.

2. The invention of claim 1, comprising at least two of said two helper springs, spaced along the length of the blades.

3. The invention of claim 2, wherein each of said helper springs is a leaf spring which engages both of said blades.

4. The invention of claim 3, wherein each of said blades has an opening through which one of the leaf springs passes, and each end of each leaf spring bends around the outer edge of a respective blade so as to retain the leaf spring in said openings.

5. The invention of claim 4, wherein the center of each leaf spring bears against the mating inner edges of the leaf spring from below when the rings are closed, and each end of each leaf spring passes upward through a respective blade opening and is bent downward around the outer edge of the blade, between the blade edge and a lateral edge of the spine.
